(19) United States
(12) Patent Application Publication
(10) Pub. No.: US 2018/0038469 A1
(43) Pub. Date: Feb. 8, 2018

(54) Method Of Making Composite Camshafts

(71) Applicant: Branson Ultrasonics Corporation, Danbury, CT (US)

(72) Inventors: Joerg BRAHM, Ridgefield, CT (US); Oliver DAPPERS, Dietzenbach (DE); Otto ALTMANN, Reit Im Winkel (DE)

(73) Assignee: Branson Ultrasonics Corporation, Danbury, CT (US)

(21) Appl. No.: 15/666,983

(22) Filed: Aug. 2, 2017

Related U.S. Application Data
(60) Provisional application No. 62/370,268, filed on Aug. 3, 2016.

(51) Int. Cl. F16H 53/02; B29C 65/00; B29C 65/16

(52) U.S. Cl. CPC F16H 53/025; B29C 65/1635; B29C 66/532; B29C 66/721; B29C 66/742; B29C 66/114; B29K 2705/00

(57) ABSTRACT

A composite camshaft is made by simultaneous through transmissive laser welding cams, bearing assemblies and load introduction parts to a fiber composite support tube.

### CROSS-REFERENCE TO RELATED APPLICATIONS

This application claims the benefit of U.S. Provisional Application No. 62/370,268 filed on Aug. 3, 2016. The entire disclosure of the above application is incorporated herein by reference.

### FIELD

The present disclosure relates to making composite camshafts for internal combustion engines.

### BACKGROUND

This section provides background information related to the present disclosure which is not necessarily prior art.

Laser welding is commonly used to weld plastic parts together. One type of laser welding is through transmissive laser welding such as through transmissive infrared laser welding, commonly referred to as TTIr. During TTIr welding, a transmissive plastic part and an absorptive plastic part are held together with a force with abutting surfaces at a weld interface in good contact with each other. Laser radiation of a suitable wavelength is passed through the transmissive part and impacts the absorptive plastic part at the weld interface and gets converted to heat by absorption by the absorptive part. This heats the absorptive plastic part at the weld interface which is heated above a melting temperature. As the absorptive plastic part melts, the heat is transferred across the weld interface to the transmissive part melting the transmissive part at the weld interface forming a molten weld at the weld interface. Once the laser is turned off, the molten weld solidifies welding the parts together at the weld interface. It should be understood that the transmissive part is also known in the art as a transparent part. It should also be understood that the absorptive part includes parts that are partially absorptive to the laser radiation.

One type of TTIr available from Branson Ultrasonics Corporation is simultaneous through transmissive infrared welding referred to herein as STTIr. In STTIr, the full weld path or area (referred to herein as the weld path) is simultaneously exposed to laser radiation, such as through a coordinated alignment of a plurality of laser light sources, such as laser diodes. An example of STTIr is described in U.S. Pat. No. 6,528,755 for “Laser Light Guide for Laser Welding,” the entire disclosure of which is incorporated herein by reference.

In STTIr, the laser radiation is typically transmitted from one or more laser sources to the parts being welded through one or more optical waveguides which conform to the contours of the parts' surfaces being joined along the weld path. FIG. 11 shows an example of a STTIr laser welding system 1100. STTIr system 1100 includes a laser support unit 1102 including one or more controllers 1104, an interface 1109, one or more power supplies 1106, and one or more chillers 1108. STTIr laser welding system 1100 also includes an actuator 1110, one or more laser banks 1112, an upper tool/waveguide assembly 1114 and a lower tool 1116 fixtured on a support table 1118. Laser support unit 1102 is coupled to actuator 1110 and each laser bank 1112 and provides power and cooling via power supply (or supplies) 1106 and chiller (or chillers) to 1108 to laser banks 1112 and controls actuator 1110 and laser banks 1112 via controller 1104. Actuator 1110 is coupled to upper tool/waveguide assembly 1114 and moves it to and from lower tool 1116 under control of controller 1104. The parts to be welded are placed in an upper tool/waveguide assembly 1114 and a lower tool 1116.

As best shown in FIG. 12, each laser bank 1112 includes one or more channels 1122 with each channel 1122 having a laser light source 1124 of laser radiation, which may illustratively be a laser diode. Each channel 1122 is coupled by a fiber bundle 1126 to a waveguide 1128 of upper tool/waveguide assembly 1114. Waveguide 1128 is fixtured in an upper tool 1130 of upper tool/waveguide 1114. Each fiber bundle 1126 splits into one or more legs 1132 with each leg terminating in a ferrule 134 at waveguide 128. (For clarity of FIG. 12, only two ferrules 1134 are identified by reference number 1134 in FIG. 12.) While not shown in FIG. 12 for clarity of FIG. 12, it should be understood that there are sufficient laser banks 1112 with associated channels 1122, fiber bundles 1126 and legs 1132 terminating in ferrules 1134 so that there are ferrules 1134 around the entire weld path defined by waveguide 1128, such as around the entire periphery of waveguide 1128, sufficient to radiate the entire weld path around with laser light. Each laser channel 1122 is controlled by controller 1104. It should be understood that each leg 1132 typically has several fibers that are part of one of the fiber bundles 1126 so that each ferrule is fed laser light by these several fibers of the associated fiber bundle 1126 from the laser light source 1124 of laser radiation of the laser channel 1122 to which the leg is coupled via the associated fiber bundle 1126.

Camshafts are used in internal combustion engines to mechanically open and close valves that let the air/fuel mixture into the cylinders of the engine and the exhaust out of the cylinder. The camshaft has cams on it, also called lobes, that push against the valves via valve lifters as the camshaft rotates the cams to valve opening positions to open the valves. Springs return the valves to their closed position as the cam shaft rotates the cams past the valve opening positions.

Typically, camshafts are made of machined steel parts. FIG. 1A shows an example of such a camshaft 10 and FIG. 1B shows an exploded view of a portion of camshaft 10. Camshaft 10 has a core shaft 12, a plurality of cams 14 (only some of which are identified with reference number 14 in FIG. 1) formed integrally with core shaft 12 or affixed to core shaft 12, a plurality of bearing assemblies 166 (two of which are identified with reference number 16 in FIG. 1) affixed to core shaft 12 and at least one load introduction part 18 formed integrally with core shaft 12 or affixed to core shaft 12. As used herein, a load introduction part is a component that bears a load, such as a load transmitted from another component such as the crankshaft, transmitting a load to another component such as a pump, or provides load support such as a mounting flange. In an aspect, the at least one load introduction part 18 includes a mounting flange 20. In an aspect, the at least one load introduction part 108 includes a timing gear 22 (FIG. 1B).

In an effort to reduce weights, camshafts have been made of fiber composite material. U.S. Pat. No. 9,574,651 (that claims priority to DE 10 2013 111 837 A1) for “Lightweight Camshaft and Method for Producing the Same” discloses a process for assembling a camshaft in composite fiber technology with mounted individual components.

DE 102 60 115 B4 for “Method for Producing a Shaft and a Shaft Produced According to this Production Method” discloses a camshaft and method for producing the camshaft by producing a tubular base body from a carbon fiber composite material, in which metal sleeves are incorporated to receive and join cam elements. WO 2016/030134 A2 for “Method for Producing a Joint on a Component Consisting of a Fibre-Composite Material) discloses joining multiple fiber composite structures to one another with metal connecting pieces.

### SUMMARY

This section provides a general summary of the disclosure, and is not a comprehensive disclosure of its full scope or all of its features.

In accordance with an aspect of the present disclosure, a method of making a camshaft for an internal combustion engine includes laser welding a plurality of cams and a plurality of bearing assemblies to a fiber composite support tube. The method includes providing a fiber composite support tube having a plurality of weld locations and providing each weld location with a plastic laser weldable material. It also includes providing a plurality of cams, providing each cam with a laser weldable portion and providing each laser weldable portion of each cam with a plastic laser weldable material. It further includes providing a plurality of bearing assemblies, providing each bearing assembly with a laser weldable portion and providing each laser weldable portion of each bearing assembly with a plastic laser weldable material. It further includes placing the plurality of cams on the fiber composite tube with each cam at a respective one of the weld locations with the plastic laser weldable material of the cam abutting the plastic laser weldable material of the weld location at which that cam was placed and placing the plurality of bearing assemblies on the fiber composite support tube with each bearing assembly at a respective one of the weld locations with the plastic laser weldable material of the bearing assembly abutting the plastic laser weldable material of the weld location at which that bearing assembly was placed. It further includes providing laser tooling that is split laser tooling for each cam and for each bearing assembly with each laser tooling associated with one of the cams or one of the bearing assemblies. It further includes closing the split tooling of the laser tooling associated with each cam or bearing assembly around the fiber composite support tube adjacent that cam or bearing assembly with which that laser tooling is associated and urging that cam or bearing assembly with that laser tooling against the associated weld location of the fiber composite support tube. It further includes generating a plurality of sets of laser beams with laser light sources of a simultaneous through transmissive infrared laser welding system with each laser beam having laser light at an absorption wavelength and with each set of laser beams associated with a respective one of laser tooling. It further includes directing each set of laser beams to the laser tooling with which that set of laser beams is associated and with that laser tooling directing that set of laser beams to a weld path at a weld interface at which the cam or bearing assembly associated with that laser tooling is welded to the associated weld location of the fiber composite support tuber to simultaneously radiate the entire weld path with laser light at the absorption wavelength.

In an aspect, the method also includes laser welding at least one load introduction part to an end of the fiber composite support tube including providing the load introduction part member with a laser weldable portion, providing the laser weldable portion of the load bearing member with plastic laser weldable material, placing the load introduction part member adjacent an end of the fiber composite support tube, providing laser tooling for the load introduction part that is associated with the load introduction part member with at least one of the sets of laser beams associated with that laser tooling associated with the load introduction part, disposing laser fiber bundles of the simultaneous through transmissive infrared laser welding system in the laser tooling associated with the load introduction part with ends of fibers of the laser fiber bundles in bores of an outer welding ring that are circumferentially spaced around a circumference of the outer welding ring, placing a housing of the laser tooling associated with the load introduction part member in a cylindrical opening of the fiber composite support tube, and directing the set of laser beams associated with the laser tooling associated with the load introduction part member to that laser tooling and directing these laser beams outwardly from the ends of the fibers of the fiber bundles to a weld path at a weld interface at which the load introduction part associated with that laser tooling is welded to the associated weld location of the fiber composite support tuber to simultaneously radiate the entire weld path with laser light at the absorption wavelength.

In an aspect, providing each bearing assembly includes providing a bearing and at least one bearing cage associated with that bearing, providing each bearing assembly with the laser weldable portion with the plastic laser weldable material includes providing the bearing cage with the laser weldable portion with the plastic laser weldable material, placing each bearing assembly on the fiber composite support tube includes placing the bearing and bearing cage of each bearing assembly on the fiber composite support tube with the bearing cage adjacent the bearing, closing the laser tooling associated with each bearing assembly includes closing it around the fiber composite support tube adjacent the bearing cage of that bearing assembly and urging that bearing cage with that laser tooling against the associated weld location of the fiber composite support tube.

In an aspect, providing each bearing assembly includes providing a bearing and a pair of bearing cages associated with that bearing and placing each bearing assembly on the fiber composite support tube includes placing the bearing and bearing cages of each bearing assembly on the fiber composite support tube with the pair of bearing cages adjacent opposite sides of the bearing.

In an aspect, providing each laser weldable portion of each cam with laser weldable material includes providing plastic laser weldable material that is transparent to the laser beams, providing each bearing assembly with plastic laser weldable material includes providing plastic laser weldable material that is transmissive to the laser beams and providing the weld locations associated with the cams and with the bearing assemblies with plastic laser weldable material includes providing plastic laser weldable material that is at least partially absorptive to the laser beams.

In an aspect, providing the plastic laser weldable material that is transparent to the laser beams includes providing one of thermoset and thermoplastic material that is transparent to the laser beams and providing the plastic laser weldable material that is partially absorptive to the laser beams includes providing one of thermoset and thermoplastic material that is partially absorptive to the laser beams.

In an aspect, providing the weld locations with plastic laser weldable material includes providing the plastic laser weldable material as an outer layer of the fiber composite support tube.

In an aspect, providing the plastic laser weldable material as the outer layer of the fiber composite support tube includes providing a thermoset or thermoplastic material that is transparent or partially absorptive to the laser beams as the outer layer of the fiber composite support tube. In an aspect, providing the thermoset or thermoplastic material as the outer layer of the fiber composite support tube includes providing as the outer layer of the fiber composite support tube a second tube of the thermoset or thermoplastic material that is transparent or partially absorptive to the laser beams.

In an aspect, the method further includes providing an interface sheet around the outer layer of the fiber composite support tube wherein the interface sheet is made of a thermoset or a thermoplastic material that is transparent or partially absorptive to the laser beams around the outer layer of the fiber composite support tube.

In an aspect, the method includes forming recesses in the fiber composite support tube at one or more of the weld locations and filling the recesses with a thermoset or thermoplastic material that is transmissive or partially absorptive to the laser beams.

In an aspect, providing the plurality of cams includes providing cams that only partially encircle the fiber composite support tube when the cams are placed on the fiber composite support tube.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A shows a prior art metal camshaft and FIG. 1B shows an exploded view of a portion of the camshaft of FIG. 1A;

FIGS. 2A-2E to show embodiments of a cam and fiber composite support tube of a composite camshaft and showing a material finish of the fiber composite support tube and a reinforced fiber layer in accordance with an aspect of the present disclosure in which FIG. 2A is a cross-section of a portion of the composite camshaft having a cam laser welded to the composite support tube, FIG. 2B is a side view of a portion of the composite cam shaft having a cam laser welded to the composite support tube, FIGS. 2C and 2D are perspective side views of a portion of the composite support tube with a laser weldable outer layer thereon, and FIG. 2E shows a matrix of polymer material in which reinforcing fibers are embedded of which the composite support tube is made in accordance with an aspect of the present disclosure;

FIGS. 3A-3D show embodiments of a cam and fiber composite support tube of a composite camshaft in accordance with an aspect of the present disclosure and showing diagrammatically laser welding thereof in which FIG. 3A is a side view of a portion of the composite support tube, FIG. 3B is a cross-section of a portion of the composite camshaft having a cam laser welded to the composite support tube, FIG. 3C is a side view of a portion of the composite cam shaft having a cam laser welded to the composite support tube and FIG. 3D is a side view of a portion of the composite cam shaft showing diagrammatically laser welding of the cam to the composite support tube;

FIGS. 4A and 4B show an embodiment of a cam and fiber composite support tube of a composite camshaft in accordance with an aspect of the present disclosure in which FIG. 4A is a cross-section of a portion of the composite camshaft having a cam laser welded to the composite support tube and FIG. 4B is a side view of a portion of the composite cam shaft having a cam laser welded to the composite support tube;

FIGS. 5A and 5B show an embodiment of a cam and fiber composite support tube of a composite camshaft with the cam only partially encircling the fiber composite support tube in accordance with an aspect of the present disclosure in which FIG. 5A is a cross-section of a portion of the composite camshaft having a cam laser welded to the composite support tube and FIG. 5B is a side view of a portion of the composite cam shaft having a cam laser welded to the composite support tube;

FIGS. 6A and 6D show an embodiment of a cam and fiber composite support tube of a composite camshaft with an interface layer around the fiber composite support tube in accordance with an aspect of the present disclosure in which FIG. 6A is a cross-section of a portion of the composite camshaft having a cam laser welded to the composite support tube, FIG. 6B is a side view of a portion of the composite cam shaft having a cam laser welded to the composite support tube, FIG. 6C is a side view of a portion of the composite cam shaft showing diagrammatically laser welding of the cam to the composite support tube, and FIG. 6D is a section along line 6D of FIG. 6B of a portion of a periphery of the composite support tube and interface layer where a portion of the cam is laser welded to the composite support tube;

FIGS. 7A-7E show an embodiment of a cam and fiber composite support tube of a composite camshaft with the fiber composite support tube having recesses filled with plastic laser weldable material in accordance with an aspect of the present disclosure in which FIG. 7A is a cross-section of a portion of the composite camshaft having a cam laser welded to the composite support tube, FIG. 7B is a portion of the composite support tube having one of the recesses, FIG. 7C shows the recess of FIG. 7B filled with the plastic laser weldable material, FIG. 7D shows schematically the laser welding at the recess of FIG. 7C and FIG. 7E is a side view of a portion of the composite cam shaft having a cam laser welded to the composite support tube;

FIGS. 8A and 8B show diagrammatically laser welding of cams to a fiber composite support tube of a composite camshaft in accordance with an aspect of the present disclosure;

FIGS. 9A-9D show diagrammatically laser welding of bearing assemblies to a fiber composite support tube of a composite camshaft in accordance with an aspect of the present disclosure;

FIGS. 10A and 10B show diagrammatically laser welding of a load introduction part to a fiber composite support tube of a composite camshaft in accordance with an aspect of the present disclosure; and

FIGS. 11 and 12 show a prior art simultaneous through transmissive infrared laser welding system.

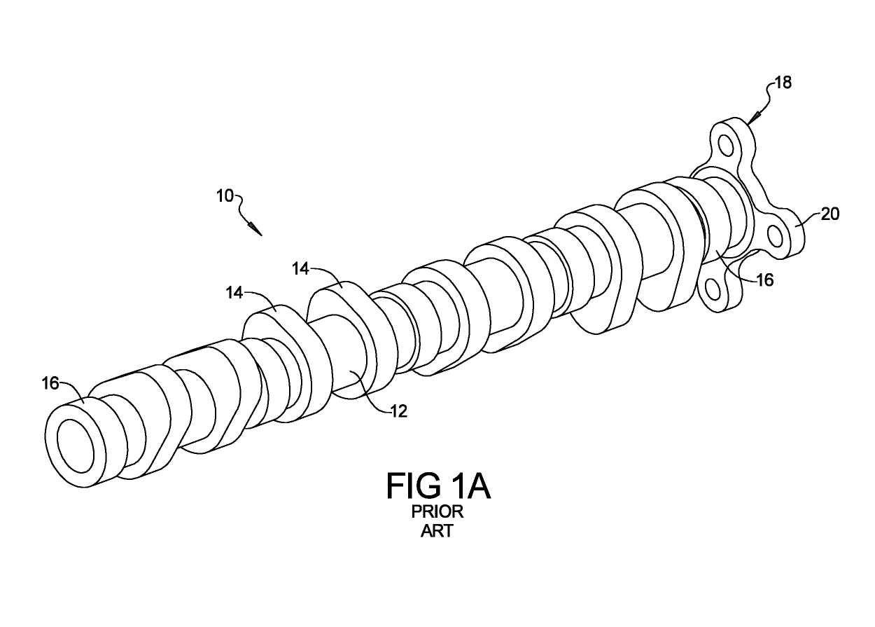

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It should be understood that arrows in the figures that are not specifically identified with a reference number indicate the incidence of laser light if shown coming from a laser light source or the direction of force if shown with arrows labeled with F.

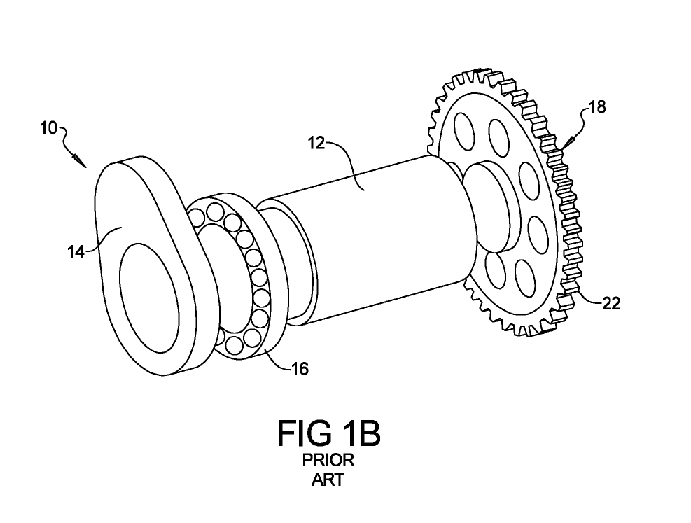

FIGS. 2A-2E to 7A-7B show example embodiments of cam 104 and fiber composite support tube 102 of a composite camshaft 100.

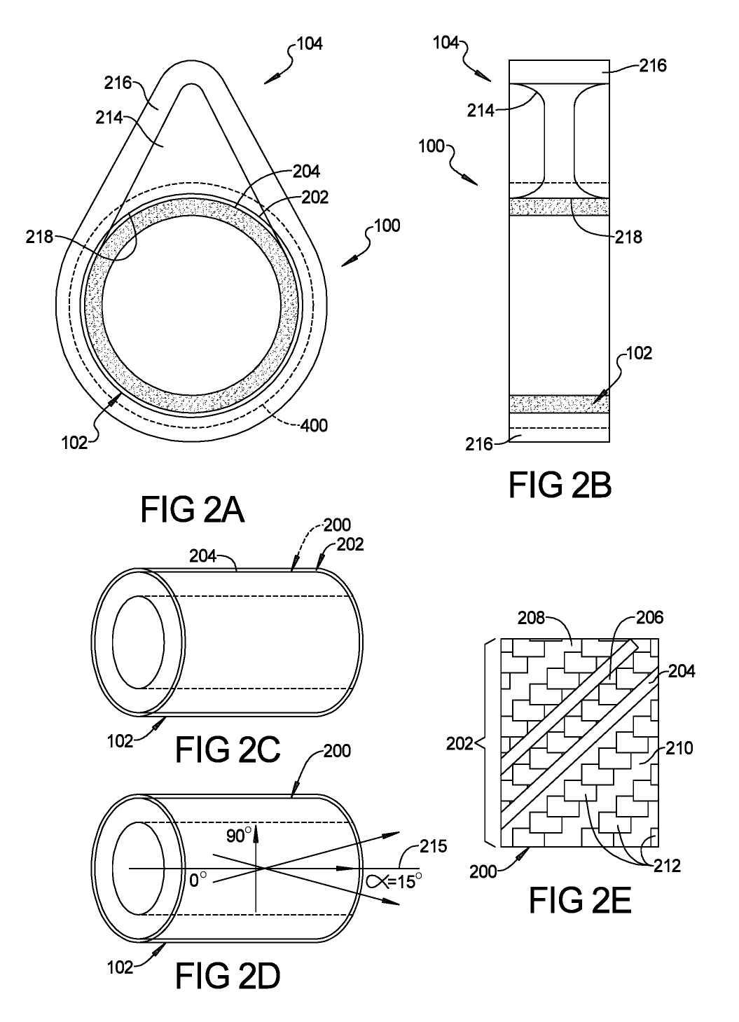

A cam 104 affixed to fiber composite support tube 102 and the structures of fiber composite support tube 102 and cam 104 are shown in more detail in FIGS. 2A-2E, 3A-3D and 4A-4B. Fiber composite support tube 102 has a core fiber composite tube 200 with a laser weldable outer layer 202 affixed to an outer surface 204 of fiber composite support tube 102. Laser weldable outer layer 202 includes a plastic material that is laser weldable, as discussed in more detail below. In the example of FIGS. 2A-2E, laser weldable outer layer 202 illustratively has an inner thermoset layer 206 of a thermoset material and an outer layer 208 of a thermoplastic material. The thermoplastic material of which outer layer 208 is made is laser weldable. It should be understood that laser weldable outer layer 202 could be a single layer of a laser weldable thermoset material or a laser weldable thermoplastic material, as shown in the embodiment of FIGS. 3A-3D. Laser weldable outer layer 202 is illustratively applied to core fiber composite tube 200 after core fiber composite 200 is fabricated, for example, by injection molding the material used for laser weldable outer layer 202 around core fiber composite tube 200. It should be understood that processes other than injection molding can be utilized to apply the material of which laser weldable outer layer 202 is made to core fiber composite tube 200.

Core fiber composite tube 200 is made of a matrix 210 of polymer material in which reinforcing fibers 212 (best shown in FIG. 2E) are embedded and retained. The matrix of polymer material 210 can be a matrix of thermoset material such as epoxy, phenolic resin, or similar thermoset material or a matrix of a high-temperature resistant thermoplastic material. Some examples of high-temperature resistant thermoplastic materials that could be used for the matrix of high temperature resistant thermoplastic material include PEEK (polyether ether keton), PPS (polyphenylene sulfide), PPA (polyphthalamide), PI (polymide) and PA (polyamide). In an aspect, the reinforcing fibers 212 are carbon fibers are oriented at a non-zero angle a with respect to a longitudinal axis 215 of core fiber composite tube 200 (best shown in FIG. 2D), such as fifteen degrees by way of example and not of limitation.

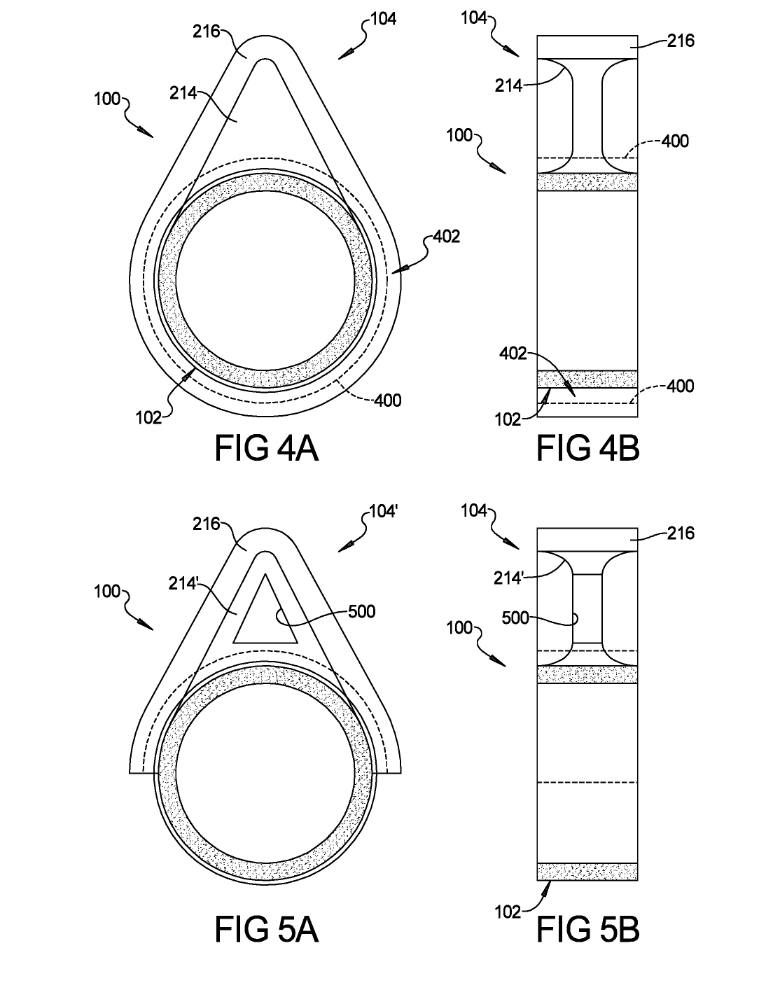

Cam 104 includes an inner stiffening member 214 and laser weldable outer portion 216 in which inner stiffening member 214 is embedded and retained. In an aspect, laser weldable outer portion 216 is made of plastic laser weldable material and in another aspect has an outer layer of plastic laser weldable material. In the example of shown in FIGS. 2A-2E, 3A-3D and 4A-4B, cam 104 entirely encircles fiber composite support tube 102. In this example, cam 104 has an inner bore 218 through which fiber composite tube 102 extends. In a variation, cam 104′ encircles only a portion a portion of fiber composite tube 102, as best shown in FIGS. 5A-5B. Cam 104′ of FIGS. 5A and 5B is a lighter weight cam than cam 104 since cam 104′ has less material than cam 104. Further, inner stiffening member 214′ of cam 104′ has a void 500 (FIG. 5A) therein further reducing the material of cam 104′. Moreover, a central structural region of this half-open cam 104′ can additionally be welded at the ends (region of the tube center line) using the laser joining technology, in order to avoid twisting of the cam 104′ under load.

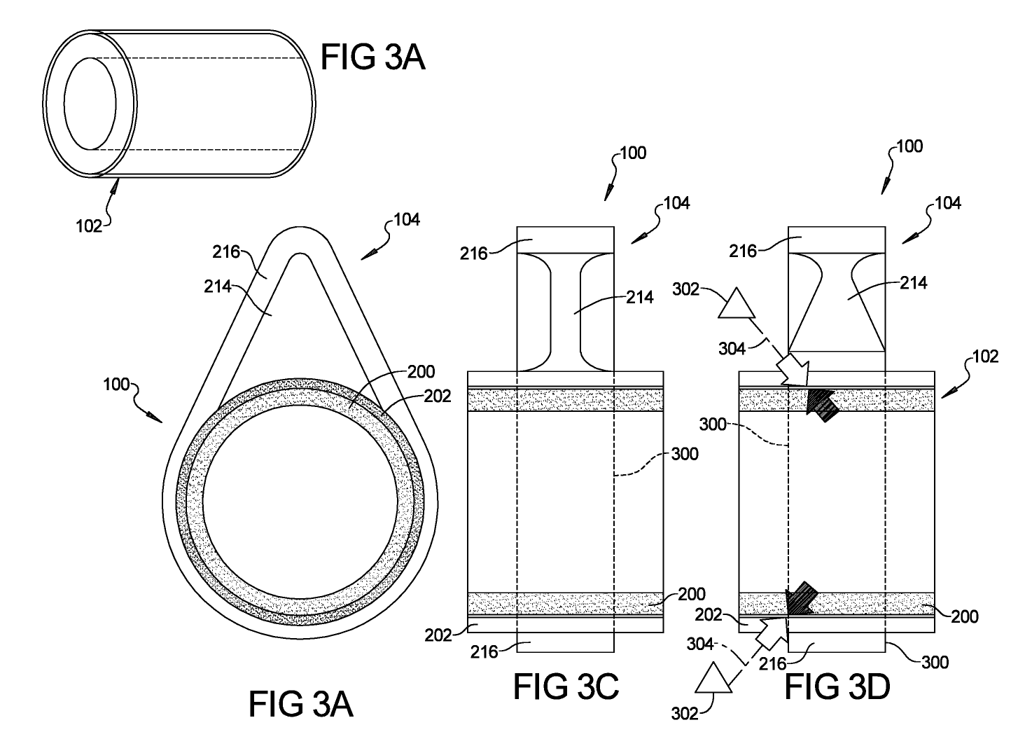

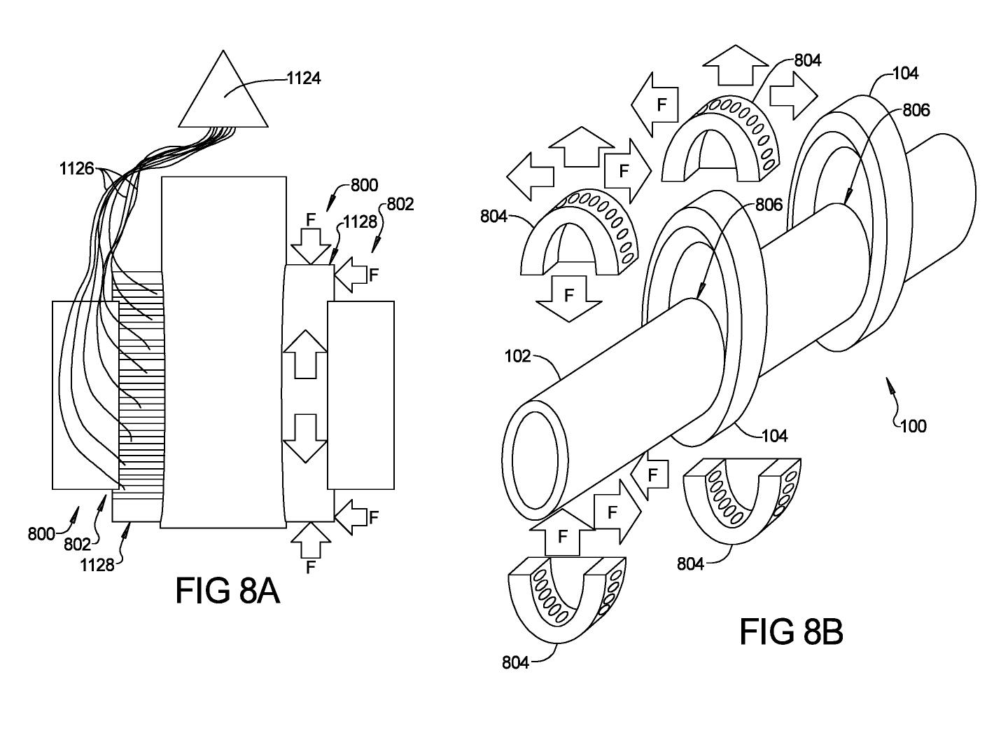

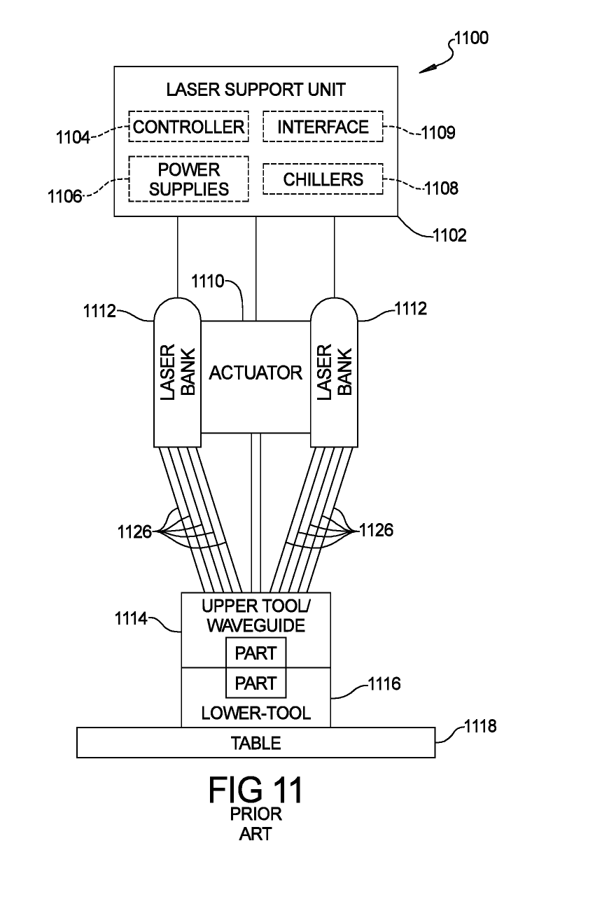

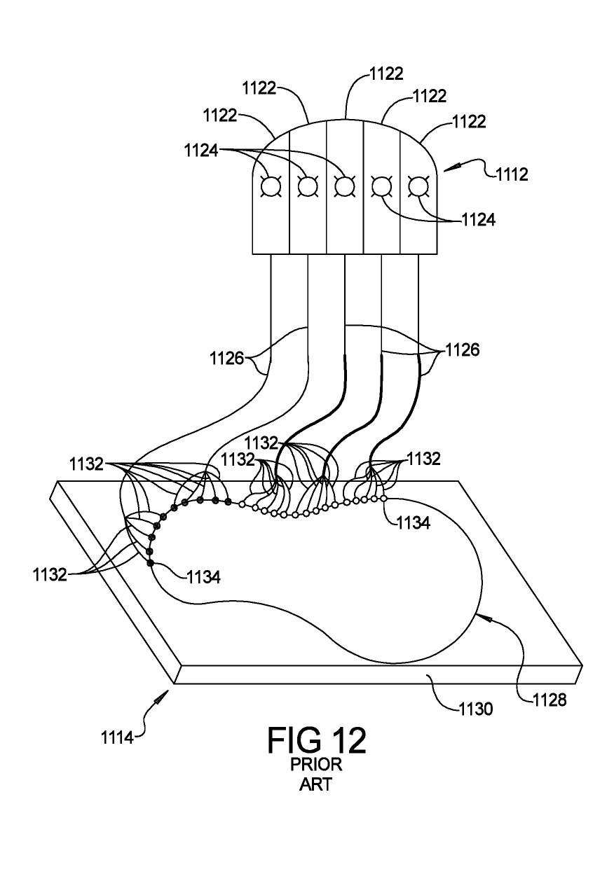

As discussed above and as discussed in more detail below, cams 104, bearing assemblies 106 and load introduction parts 108 are laser welded to fiber composite support tube 102. These components that are laser welded to fiber composite support tube 102 are collectively referred to as welded components. The welded components are placed on fiber composite support tube 102 at locations on fiber composite support tube 102 at which they are to be welded, referred to herein as weld locations 806 (FIG. 8), only two of which are shown in FIG. 8. Fiber composite support tube 102 is placed in a simultaneous through transmissive laser welding system and tooling of split tooling sets closed against each of the welded components. Using one of cams 104 as an example and with reference to FIGS. 3C and 3D, laser tooling 300 (shown schematically in FIGS. 3C and 3D) is closed against cam 104 with laser tooling 300 on either side of cam 104 and applying force to cam 104 to force it against fiber composite tube 102. Laser beams 304 generated by laser light sources 302 (both shown schematically in FIGS. 3C and 3D) of the simultaneous through transmissive laser welding system are directed to laser tooling 300 which directs the laser beams to a weld path 400 (FIGS. 4A-4B) at a weld interface 402 at which cam 104 is laser welded to fiber composite tube 102 to simultaneously radiate the entire weld path with the laser light at the absorption wavelength. Laser light sources may illustratively be laser light sources 1124 STTIr laser welding system 1100 (FIG. 11). In the example of FIGS. 3A-3D, the laser weldable outer portion 216 of cam 104 is transmissive at the absorption wavelength and the laser weldable outer layer 202 of fiber composite support tube 102 is partially absorptive at the absorption wavelength. The laser light has a wavelength that is the absorption wavelength. FIG. 3D shows schematically directions of incidence of laser beams 304 when they impinge the laser weldable outer portion 216 of cam 104.

The laser weldable outer portion 216 of cam 104 and the laser weldable outer layer 202 of fiber composite support tube 102 are made of plastic materials compatible with being laser welded to each other. For example, they may each be the same thermoplastic material or be thermoplastic materials having comparable melting temperatures. One of the laser weldable outer layer 202 of fiber composite support tube 102 and the laser weldable outer portion of cam 104 is partially absorptive at an absorption wavelength to laser light having the absorption wavelength that is used for the laser welding and the other is transmissive at the absorption wavelength. It should be understood that an additive could be applied at the interface of the laser weldable outer layer 202 of fiber composite support tube 102 and the laser weldable outer portion 216 of cam 104 to provide the partial absorptivity.

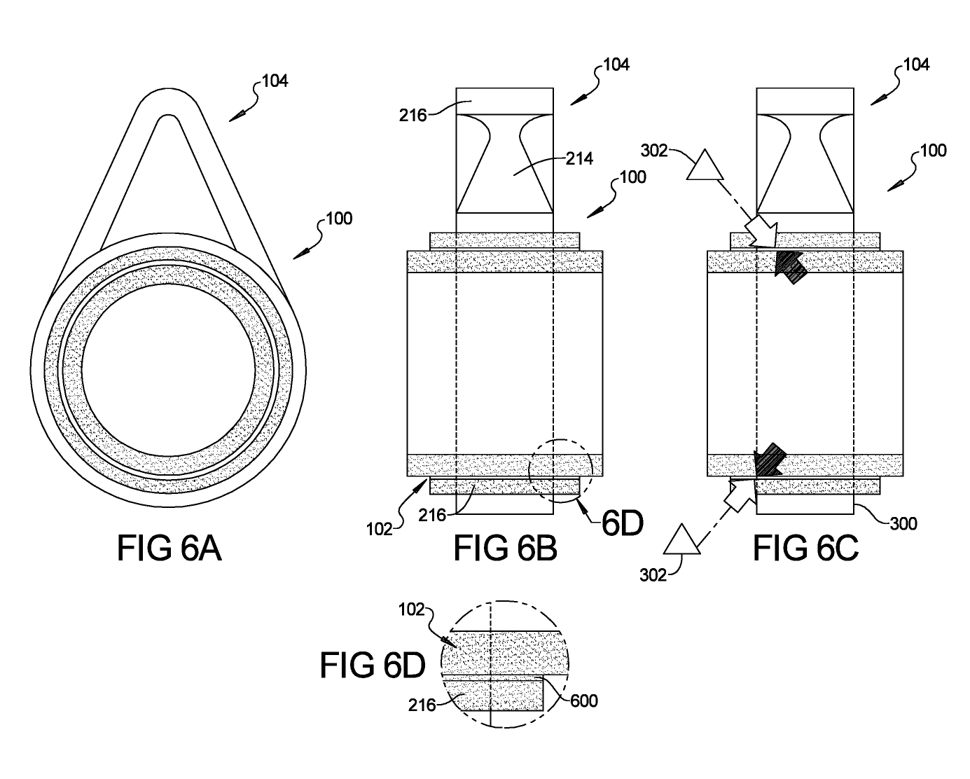

In a variation as shown in FIGS. 6A-6D, laser weldable outer layer 202 of composite fiber support tube 102 is a second tube 600 (composed of a thermoplastic/thermoset material composition, composed of a thermoset material, or composed of a thermoplastic material) or a layer sprayed on to fiber composite tube 102 in a two-component injection molding process composed of a thermoplastic/thermoset material combination, composed of a thermoset material, or composed of a thermoplastic material, wherein the laser weldable outer portion 216 of cam 104 is made of the same material as laser weldable outer layer 202.

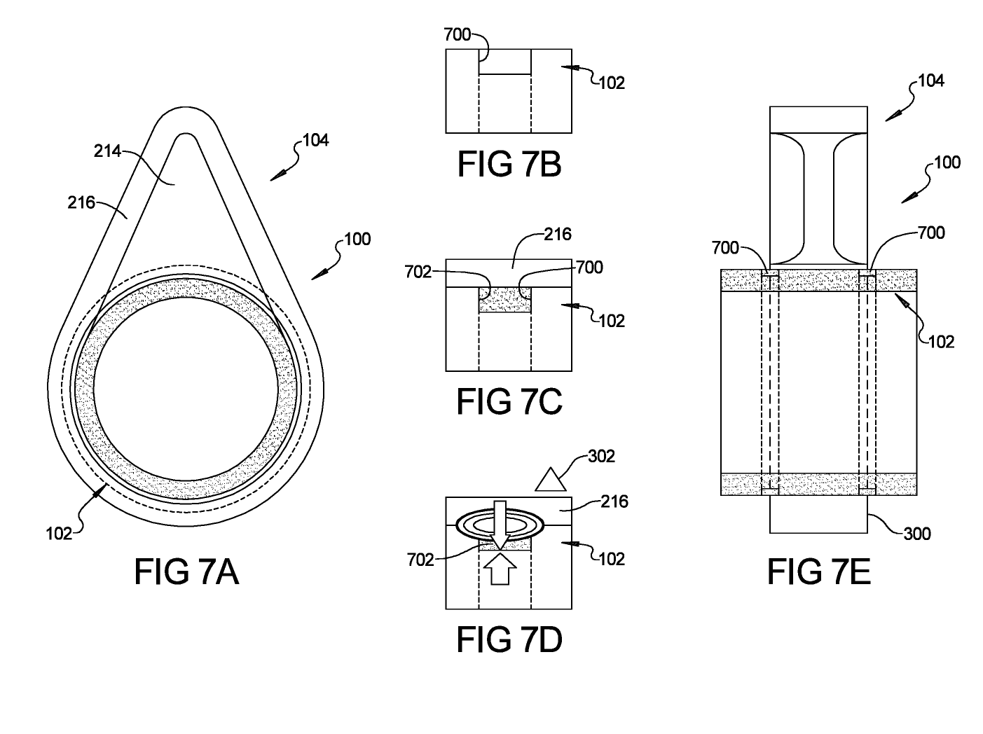

In a variation shown in FIGS. 7A-7E, fiber composite support tube 102 includes recesses 700 at one or more of the weld locations 806 filled with a laser transparent material 702 such as in a two component injection molding process. The weld component welded to the fiber composite support tube 102 at each of the weld locations having such recesses 700 are then laser welded, at least in part, to the laser transparent material in the recesses 700. In this regard, recesses 700 are formed in fiber composite support tube 102 as shown in FIG. 7B. The recesses 700 are then filled with the laser transparent material as shown in FIG. 7C. Cam 104 (used as an example), is then laser welded to the fiber composite support tube 102 by at least in part laser welding laser weldable outer portion 216 of cam 104 to the laser transparent material in the associate recesses 700, as shown in FIG. 7D with the resulting welded structure shown in FIG. 7E. The foregoing method of component preparation and laser welding advantageously ensures a high weld seam quality, since integral laser weld joints can be optimized herewith. If the material melt projects over the surface somewhat, additional anti-slip protection of the cam 104 on the composite support tube 102 is achieved using this method.

As discussed above, simultaneous through transmissive laser welding is used to weld the welded components to fiber composite support tube 102. FIG. 11. With reference to FIG. 8, the laser welding technology and associated laser tool technology for welding the welded components of composite camshaft 100 to fiber composite support tube 102 are described with reference to laser welding cams 104 to fiber composite support tube 102. As discussed above, the laser welding technology used is simultaneous through transmission infrared laser welding and utilizes a simultaneous through transmission infrared laser welding system such as simultaneous through transmission infrared laser welding system 1100, with the modifications discussed herein. A plurality of laser light sources for generating a plurality of laser beams are shown representatively by laser light source 1124, and which works in an advantageous energy and wavelength range as discussed above. Fiber bundles 1126 transmit the laser beams generated by lasers 1124 to laser tooling 800 which directs the laser beams to the components being welded, which in the example of FIG. 8 are cams 104 being welded to fiber composite support tube 102. In an aspect, laser tooling 800 includes an appropriately configured waveguide along the lines of waveguide 1128 discussed above. Laser tooling 800 includes split tooling 802. When welding cams 104, laser tooling 800 includes right and left split tooling 802. Each split tooling 802 is divided into two halves 804 so that split tooling 802 can be opened and closed around composite fiber support tube 102.

Each cam 104 is positioned on fiber composite support tube 102 at the weld location 806 on fiber composite support tube 102 at which that cam 104 is to be welded to fiber composite support tube 102. In this regard, there is a weld location 806 on fiber composite support tube 102 at which each welded component is welded to fiber composite support tube 102, with the weld location for each welded component referred to herein as a weld location 806 associated with that welded component. It should be understood that fiber composite support tube 102 can have the laser weldable outer layer 202 only at each weld location 806.

The tool halves 804 of the right and left split tooling 802 of laser tooling 800 associated with each cam 104 are closed around fiber composite support tube 102 abutting opposite sides of the associated cam 104. The requisite contact pressure of laser tooling 800 split tooling with force F ensures that the cams 104 are optimally pressed on fiber composite support tube 102. Opening and closing of tool halves 804 takes place by means of a separate electrically/electronically operated mechanism (not shown). The laser tooling associated with each cam 104 is configured such that there is room between adjacent weld locations 806 so that the right and left split tooling of the laser tooling 800 associated with each cam 104 can be arranged to both the left and the right of each cam 104. While the foregoing has been described with reference to cams 104, it should be understood that it applies equally to bearing assemblies 106.

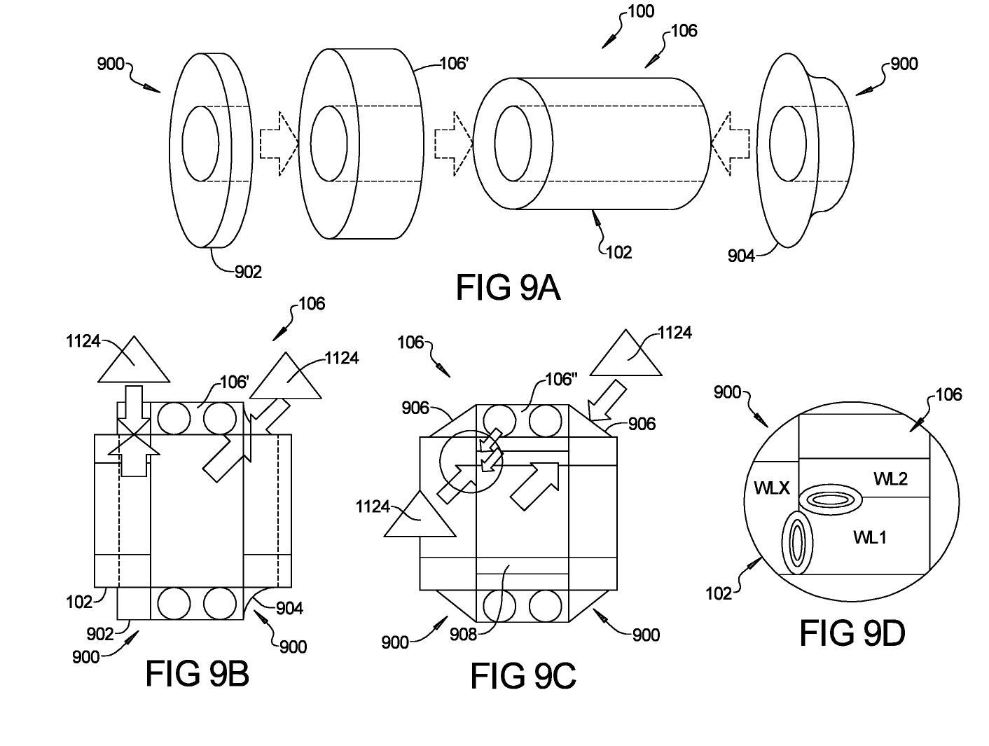

Laser welding metal components to fiber composite support tube 102 presents a challenge since the metal components cannot be penetrated by laser beam 304 and thus cannot be directly laser welded to fiber composite support tube 102. In an aspect, the bearings of bearing assemblies 106 are such metal components (such as bearing 106′ shown in FIG. 9B) and a method of attaching bearing 106′ that is a metal component to composite fiber support tube 102 is described with reference to FIGS. 9A-9C. The bearing assembly 106 includes metal bearing 106′ and at least one laser weldable bearing cage 900. Metal bearing 106′ is placed on fiber composite support tube 102 at the appropriate weld location. Laser weldable bearing cage 900 is placed on fiber composite support tube 102 against each side of metal bearing 106′. In an aspect, laser weldable bearing cage 900 is made of a plastic laser weldable material, such as the plastic laser weldable material of which laser weldable outer layer 202 of fiber composite support tube 102 is made and each laser weldable bearing cage 900 is then directly laser welded to laser weldable outer layer 202 of fiber composite support tube 102. Laser tooling 800 (not shown in FIGS. 9A-9C) is also used in laser welding the laser weldable bearing cages 900 to composite fiber support tube 102. The tool halves 804 of the applicable split laser tooling 802 are closed around composite fiber support tube 102 abutting the laser weldable bearing cage 900 on one side of bearing assembly 106 and the tool halves of the applicable split laser tooling 802 are closed around composite fiber support tube 102 abutting the laser weldable bearing cage 900 on the other side of bearing assembly 106 and the laser weldable bearing cages 900 laser welded to composite fiber support tube 102.

FIG. 9C shows a bearing assembly 106 that includes a plastic/metal bearing 106″. Bearing 106″ includes a plastic portion 908 that may for example be an inner race of bearing 106″ and is illustratively made of a plastic laser weldable material. In securing bearing assembly 106 to fiber composite support tube 102, plastic portion 908 of bearing 106″ is illustratively laser welded to laser weldable outer layer 202 of fiber composite support tube 102, laser welded to each laser weldable bearing cage 900, or laser welded to both laser weldable outer layer 202 of fiber composite support tube 102 and each laser weldable bearing cage 900.

Depending on the choice of process, it is also possible to weld multiple laser welding surfaces (for example, WL1 and WL2 to WLX) in one work operation, as illustrated in FIG. 9D.

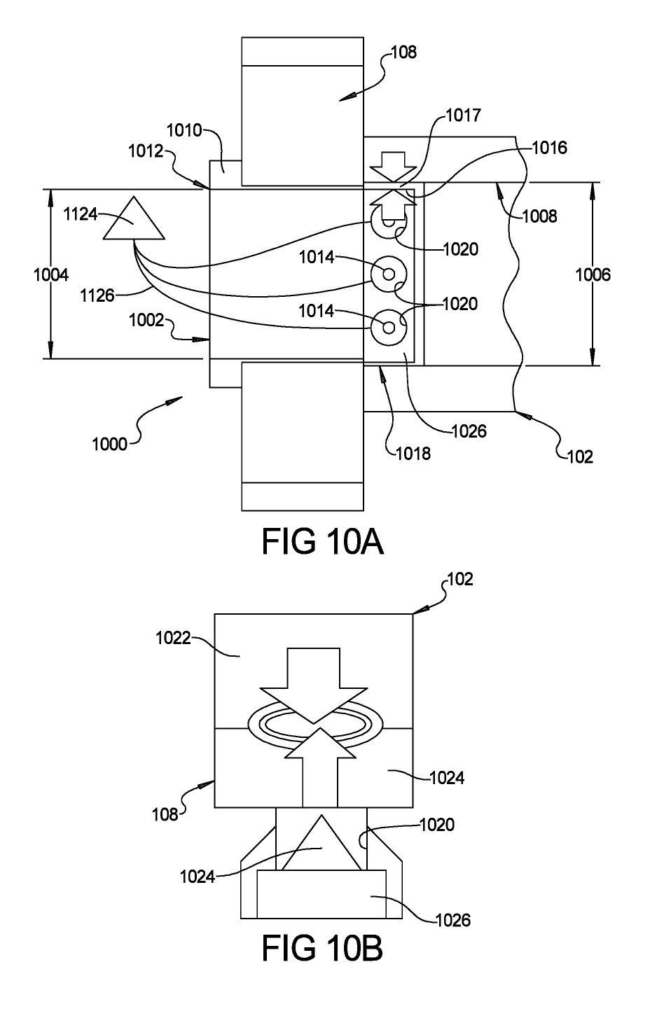

The load introduction parts 108, such as gears and flanges, that must be joined to the fiber composite support tube 102 present a challenge in the technology of joining to camshafts. Because these load introduction parts are generally at the beginning or end of the composite camshaft 100, it is possible to employ joining techniques such as lasers to weld the load introduction parts to the fiber composite support tube 102, as now described with reference to FIGS. 10A and 10B. In this regard, fiber composite support tube 102 has an laser weldable inner layer 1022 (FIG. 10B) made of plastic laser weldable material of the same type as the plastic laser weldable material of which laser weldable outer layer 202 of fiber composite support tube 102 is made and load bearing part 108 has a corresponding laser weldable portion 1024 made of plastic laser weldable material compatible with being laser welded with the plastic laser weldable material of laser weldable inner layer 1022.

Laser tooling 1000 has a housing 1002 having an outside diameter 1004 that corresponds to an inside diameter 1006 of an inner cylindrical opening 1008 of fiber composite support tube 102. That is, the outside diameter 1004 is the same (less a tolerance) as the inside diameter 1006 of inner cylindrical opening 1008. A spacer 1010 is secured around an axial outer end 1012 of housing 1002 and is dimensioned to precisely locate ends 1014 of laser fiber bundles 1126 in inner cylindrical opening 1008 to radiate weld path 1016 along a weld interface 1017 where fiber composite support tube 102 is laser welded to load introduction part 108. An outer welding tool ring 1018 has bores 1020 for the laser fiber bundles 1126 which are arranged circumferentially so that ends 1014 of laser fiber bundles 1126 are spaced around a circumference 1026 of outer welding tool ring 1018. The bores 1020 are spaced around circumference 1026 of outer welding tool ring 1018 so that the laser light emitted from ends 1014 of laser fiber bundles 1126 simultaneously radiates the entire weld path 1016 along the weld interface 1017. In this regard, the laser beams exiting ends 1014 of laser fiber bundles have a circular or elliptical shape and the bores 1020 are illustratively spaced so that adjacent laser beams overlap along weld path 1016 and thus a high quality, full-area weld joint is produced.

As is known in the part, a variety of factors influence the laser weldability of plastic materials (thermosets and thermoplastics) that are transmissive to laser light at the wavelength being used and materials that are absorptive or partially absorptive to that laser light. With regard to fiber composite support tube 102, factors such as the fiber and matrix materials, the volume percent of continuous reinforcing fibers and short fibers, as well as the type and even the colors (with different fillers), have an effect on the laser transparency. In laser welding, there is always a need for partially absorptive and transmissive layers in the components to be joined. Even in the case of the thermoplastic materials (that otherwise have good laser transmissivity, there are significant differences in laser transmissivity for amorphous and semi-crystalline polymer materials. Laser-transmissive thermoset materials, such as special types of epoxy resin, are known that to some extent have higher laser transmissivity rates than some thermoplastic materials, such as, e.g., PPS or PEEK. The critical factor is the wavelength A (nm) of the laser light being used for laser welding and that must transit through the transmissive part and be at least partially absorbed by the partially absorptive part at the weld interface.

The weight of a structure for equal strength is an important factor for lightweight structures, which are of particular interest for motor drive masses that are subject to high acceleration. Carbon fiber composites have lightweight construction parameters that are better by nearly a factor of 5 than most other materials. Even though such lightweight carbon fiber composites are known, relatively heavy energy-dissipating metal camshafts continue to be used.

Somewhat more expensive, but worthwhile, are flat fiber composite tube support structure surfaces with low surface roughness parameters joint layers finished by means of grinding, or another method if necessary, between the tube and the assembled components. Tight tolerances for plane parallelism of the components, for roundness (average values 1.5*10̂−3 mm), and for tube inside diameter (thickness variations of less than 0.1 mm for the fiber composite support tube outside diameter and inside diameter) are needed on account of the installation of the attached parts and the imbalance for components subjected to high acceleration.

In accordance with an aspect of the present disclosure, thermally stable fiber composite support tube structures are achieved in the fiber/matrix filament winding process with a winding angle of approximately 15° (see, FIG. 2D), with, e.g., carbon reinforcing fibers, in a thermoplastic or thermoset matrix with a thermal linear expansion approaching “0” (10̂6̂ mm*K̂−1), at an average density of 1.78 g/cm̂3) (see, FIGS. 2A-2E). Comparable metal camshaft support structures have substantially higher thermal linear expansion parameters—aluminum (23.1 10̂6̂ mm*K̂−1, at a density of 2.7 g/cm̂3) and steel (11.8 10̂6̂ mm*K̂−1, at a density of 7.85 g/cm̂3). Thermal linear expansion or volume expansion gives rise in fueled motors with relatively high temperatures to stresses and local deformations of the camshaft that can have a significant adverse effect on function, which speaks for fiber composite camshafts for these design and function parameters as well.

Controller 1104 can be or includes any of a digital processor (DSP), microprocessor, microcontroller, or other programmable device which are programmed with software implementing the above described logic. It should be understood that alternatively it is or includes other logic devices, such as a Field Programmable Gate Array (FPGA), a complex programmable logic device (CPLD), or application specific integrated circuit (ASIC). When it is stated that controller 1104 performs a function or is configured to perform a function, it should be understood that controller 1104 is configured to do so with appropriate logic (such as in software, logic devices, or a combination thereof. When it is stated that controller 1104 has logic for a function, it should be understood that such logic can include hardware, software, or a combination thereof.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of making a camshaft for an internal combustion engine, comprising, laser welding a plurality of cams and a plurality of bearing assemblies to a fiber composite support tube that includes:
providing a fiber composite support tube having a plurality of weld locations and providing each weld location with a plastic laser weldable material;
providing a plurality of cams, providing each cam with a laser weldable portion and providing each laser weldable portion of each cam with a plastic laser weldable material;
providing a plurality of bearing assemblies, providing each bearing assembly with a laser weldable portion and providing each laser weldable portion of each bearing assembly with a plastic laser weldable material;
placing the plurality of cams on the fiber composite tube with each cam at a respective one of the weld locations with the plastic laser weldable material of the cam abutting the plastic laser weldable material of the weld location at which that cam was placed;
placing the plurality of bearing assemblies on the fiber composite support tube with each bearing assembly at a respective one of the weld locations with the plastic laser weldable material of the bearing assembly abutting the plastic laser weldable material of the weld location at which that bearing assembly was placed;
providing laser tooling that is split laser tooling for each cam and for each bearing assembly with each laser tooling associated with one of the cams or one of the bearing assemblies;
closing the split tooling of the laser tooling associated with each cam or bearing assembly around the fiber composite support tube adjacent that cam or bearing assembly with which that laser tooling is associated and urging that cam or bearing assembly with that laser tooling against the associated weld location of the fiber composite support tube;
generating a plurality of sets of laser beams with laser light sources of a simultaneous through transmissive infrared laser welding system with each laser beam having laser light at an absorption wavelength and with each set of laser beams associated with a respective one of laser tooling; and
directing each set of laser beams to the laser tooling with which that set of laser beams is associated and with that laser tooling directing that set of laser beams to a weld path at a weld interface at which the cam or bearing assembly associated with that laser tooling is welded to the associated weld location of the fiber composite support tuber to simultaneously radiate the entire weld path with laser light at the absorption wavelength.

2. The method of claim 1 further including laser welding at least one load introduction part to an end of the fiber composite support tube, including:
providing the load introduction part member with a laser weldable portion and providing the laser weldable portion of the load bearing member with plastic laser weldable material;
placing the load introduction part member adjacent an end of the fiber composite support tube;
providing laser tooling for the load introduction part that is associated with the load introduction part member with at least one of the sets of laser beams associated with that laser tooling associated with the load introduction part;
disposing laser fiber bundles of the simultaneous through transmissive infrared laser welding system in the laser tooling associated with the load introduction part with ends of fibers of the laser fiber bundles in bores of an outer welding ring that are circumferentially spaced around a circumference of the outer welding ring;
placing a housing of the laser tooling associated with the load introduction part member in a cylindrical opening of the fiber composite support tube; and
directing the set of laser beams associated with the laser tooling associated with the load introduction part member to that laser tooling and directing these laser beams outwardly from the ends of the fibers of the fiber bundles to a weld path at a weld interface at which the load introduction part associated with that laser tooling is welded to the associated weld location of the fiber composite support tuber to simultaneously radiate the entire weld path with laser light at the absorption wavelength.

3. The method of claim 1 wherein providing each bearing assembly includes providing a bearing and at least one bearing cage associated with that bearing, providing each bearing assembly with the laser weldable portion with the plastic laser weldable material includes providing the bearing cage with the laser weldable portion with the plastic laser weldable material, placing each bearing assembly on the fiber composite support tube includes placing the bearing and bearing cage of each bearing assembly on the fiber composite support tube with the bearing cage adjacent the bearing, closing the laser tooling associated with each bearing assembly includes closing it around the fiber composite support tube adjacent the bearing cage of that bearing assembly and urging that bearing cage with that laser tooling against the associated weld location of the fiber composite support tube.

4. The method of claim 3 wherein providing each bearing assembly includes providing a bearing and a pair of bearing cages associated with that bearing and placing each bearing assembly on the fiber composite support tube includes placing the bearing and bearing cages of each bearing assembly on the fiber composite support tube with the pair of bearing cages adjacent opposite sides of the bearing.

5. The method of claim 1 wherein providing each laser weldable portion of each cam with laser weldable material includes providing plastic laser weldable material that is transparent to the laser beams, providing each bearing assembly with plastic laser weldable material includes providing plastic laser weldable material that is transmissive to the laser beams and providing the weld locations associated with the cams and with the bearing assemblies with plastic laser weldable material includes providing plastic laser weldable material that is at least partially absorptive to the laser beams.

6. The method of claim 5 wherein providing the plastic laser weldable material that is transparent to the laser beams includes providing one of thermoset and thermoplastic material that is transparent to the laser beams and providing the plastic laser weldable material that is partially absorptive to the laser beams includes providing one of thermoset and thermoplastic material that is partially absorptive to the laser beams.

7. The method of claim 1 wherein providing the weld locations with plastic laser weldable material includes providing the plastic laser weldable material as an outer layer of the fiber composite support tube.

8. The method of claim 7 wherein providing the plastic laser weldable material as the outer layer of the fiber composite support tube includes providing a thermoset or thermoplastic material that is transparent or partially absorptive to the laser beams as the outer layer of the fiber composite support tube.

9. The method of claim 8 wherein providing the thermoset or thermoplastic material as the outer layer of the fiber composite support tube includes providing as the outer layer of the fiber composite support tube a second tube of the thermoset or thermoplastic material that is transparent or partially absorptive to the laser beams.

10. The method of claim 8 further including providing an interface sheet around the outer layer of the fiber composite support tube wherein the interface sheet is made of a thermoset or a thermoplastic material that is transparent or partially absorptive to the laser beams around the outer layer of the fiber composite support tube.

11. The method of claim 1 including forming recesses in the fiber composite support tube at one or more of the weld locations and filling the recesses with a thermoset or thermoplastic material that is transmissive or partially absorptive to the laser beams.

12. The method of claim 1 wherein providing the plurality of cams includes providing cams that only partially encircle the fiber composite support tube when the cams are placed on the fiber composite support tube.
